(19) United States
(12) Patent Application Publication
(10) Pub. No.: US 2004/0211320 A1
(43) Pub. Date: Oct. 28, 2004

(54) Integration of a metallic substrate into a plastic induction system

(76) Inventor: Rodney H. Cain, Swartz Creek, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/420,563

(22) Filed: Apr. 22, 2003

(51) Int. Cl. B01D 53/02

(52) U.S. Cl. 96/108

(57) ABSTRACT

An air induction system for inspiration of clean air into an engine. In one embodiment, the system includes a pair of hollow molded members for communication of air flow therethrough. Each of the molded members has an end. A metal substrate having a hollow passage is located between the ends of the molded members, and the metal substrate has a first end and a second end. The first end is connected to the end on one of the molded members, and the second end is connected to the end on the other molded member to form a pathway for air to flow through the molded members and the metal substrate. The metal substrate may be coated with a material for adsorbing hydrocarbons, and it may be connected to the molded members with an over molded connection joint. The connection joint is designed to provide a permanent leak resistant connection between the metal substrate and molded members.

### BACKGROUND OF THE INVENTION

This invention relates to an air induction system, and in particular to an air induction system including molded ducts and a metal substrate that may be used as a hydrocarbon adsorber.

There continues to be a push to reduce emissions from internal combustion engines. One manner in which emissions are generated from an internal combustion engine is when the engine is shut off. Fuel which has been released from fuel injectors, but has not been consumed prior to engine shut down may evaporate and be released to the atmosphere while the vehicle is sitting over time after use. The evaporated fuel can pass outwardly through the intake manifold, the intake air ducts and air filter and may escape into the atmosphere and contribute to air pollution.

In an effort to reduce these types of inadvertent evaporative emissions, many types of filters have been developed. Examples of filters for use in the intake system of a vehicle are found in U.S. Pat. No. 6,432,179 to Lobovsky et al. and U.S. Patent Application Publication No. U.S. 2002/0029693 to Sakakibara et al, both of which are incorporated herein by reference. While these known devices provide some means for reducing evaporated fuel emissions, the need still exists for improved means of reducing evaporative emissions in an economical manner and for an improved means of installing the hydrocarbon filter in the intake system.

The present invention includes a means of installing a metal substrate in the induction system that can be constructed to serve as a hydrocarbon/evaporated fuel adsorbing device. The invention includes a manner of installing the device that may include an over molded connection joint manufactured using the injection molding process. An injection produced over mold is well known for attaching a collar on a blow molded air duct as is shown in U.S. Pat. Nos. 5,529,743; 5,682,924; and 6,041,824 all to Powell and U.S. Pat. No. 6,135,158 to Kraus, all of which are incorporated herein by reference. However, these patents do not disclose a method for attaching a metal substrate directly to a molded tube or duct and do not disclose using the injection molded process for installing a hydrocarbon adsorbing device.

It is therefore an object of the invention to provide a metal substrate in an air induction system. A further object of the invention is that the metal substrate may include hydrocarbon adsorbing material and that the substrate may be connected directly to a molded tube or duct using an over molded connection joint. It is another object of the invention that a metal substrate having a hydrocarbon adsorbing material coated thereon is inserted within molded ducts of an intake system, and a leak resistant connection is established between ends of the duct members to encase the metal substrate.

### SUMMARY OF THE INVENTION

The objects of the invention have been met by providing an air induction system for inspiration of clean air into an engine. In one embodiment, the system includes a pair of hollow molded members for communication of air flow therethrough. Each of the molded members has an end. A metal substrate having a hollow passage is located between the ends of the molded members, and the metal substrate has a first end and a second end. The first end is connected to the end on one of the molded members, and the second end is connected to the end on the other molded member to form a pathway for air to flow through the molded members and the metal substrate.

It is yet another feature of the invention to provide an embodiment of an air induction system for inspiration of clean air into an engine that includes a pair of hollow molded members for communication of air flow therethrough, and wherein each of the molded members has an end. The ends are connected together. The system may include a metal substrate having a hollow passage and wherein the substrate is located within at least a portion of one of the molded members. The metal substrate is coated with a material on an interior surface thereof for adsorbing hydrocarbons in the air induction system. The molded members and the metal substrate form a pathway for air to flow therethrough.

It is another feature of the invention to provide an embodiment of an air induction system for inspiration of clean air into an engine wherein the induction system includes a pair of hollow molded members for communication of air flow therethrough and a metal substrate with a hollow passage located between the molded members. The metal substrate may be coated with a material for adsorbing hydrocarbons in the induction system, and the metal substrate may be connected to each of the molded members by an over molded connection joint to form a pathway for air to flow through the molded members and the metal substrate.

### BRIEF DESCRIPTION OF THE DRAWINGS

FIG. 1 is a side view of a portion of an induction system showing a hollow metal substrate between hollow molded members with a partial cross-sectional view to show the over molded connection joint therebetween;

FIG. 2 is a close up of a over molded connection joint between the metal substrate and one of the hollow molded members taken as shown in FIG. 1;

FIG. 3 is a side view of an alternate embodiment showing the metal substrate located within the hollow molded members and spanning the connection joint therebetween with a partial cross-sectional view showing shoulders in the molded members for locating the metal substrate;

FIG. 4 is a close up view of the shoulder area of FIG. 3;

FIG. 5 is another embodiment of a metal substrate enclosed within the hollow molded members and wherein the members include a raised internal rib for locating the metal substrate;

FIG. 6 is a close up taken as shown in FIG. 5 of the raised rib locating the metal substrate; and

FIG. 7 is a side view of another embodiment showing the metal substrate contained predominately within one of the hollow molded members and wherein a connection joint connecting the molded members to one another is formed adjacent an end of the metal substrate.

### DETAILED DESCRIPTION OF EMBODIMENTS OF THE INVENTION

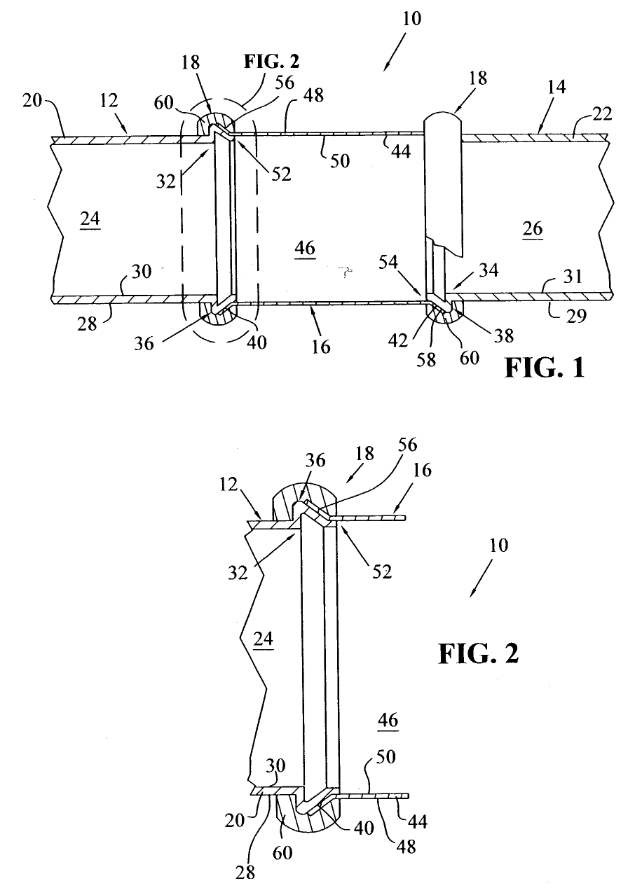

Now referring to FIGS. 1 and 2, a portion of an air induction system is shown generally indicated as 10. The air induction system 10 includes a pair of molded/polymer members or air ducts generally indicated as 12 and 14, and a metal substrate generally indicated as 16. Metal substrate 16 is connected to molded ducts 12 and 14 by respective over molded connection joints generally indicated as 18. In a typical system, one of the molded ducts 12 or 14 will be connected to the air intake of an engine (not shown), and the other molded duct will be connected to an intake air passage on the side of the system where the air cleaner (not shown) is located.

Molded ducts 12 and 14 may be of any configuration having a generally hollow passage way to facilitate airflow therethrough. In the embodiment shown, molded ducts 12 and 14 have a generally circular or tubular configuration. Molded ducts 12 and 14 may be made using the well-known blow molding process or any other suitable known molding process. Ducts 12 and 14 also include walls 20, 22 and inner airflow passages 24, 26, respectively. Walls 20 and 22 have respective outer surfaces 28, 29 and inner surfaces 30, 31.

Molded ducts 12 and 14, also, each include an end portion generally indicated as 32, 34, respectively. In the embodiment shown, end portions 32, 34 both include a raised ridge generally indicated as 36, 38, respectively. Raised ridges 36, 38 each extend outwardly above the respective outer surfaces 20, 22, and each raised ridge includes a sloped surface 40, 42, respectively.

Metal substrate 16 is also of a cylindrical or tubular configuration and includes a wall 44 and inner air flow passage 46. Wall 44 includes an outer surface 48 and an inner surface 50. Metal substrate 16 also includes opposing ends generally indicated as 52, 54 with each end having an outwardly flared portion 56, 58, respectively. Metal substrate 16 is preferably made from a material such as stainless steel or aluminum that will be resistant to corrosion and the harsh environment surrounding an engine. To make metal substrate 16 function as a hydrocarbon adsorber, the inner surface 50 can be coated with an activated carbon material or any other known material for adsorbing hydrocarbons. Materials also useful to remove volatile hydrocarbons by absorption are molecular sieves such as zeolite or porous polymer beads. The adsorbent or absorbent material may be coated on the interior of the metal substrate using known processes and adhesives/binders.

Over molded connection joints 18 include an injection molded material 60 for providing a firm connection between metal substrate 16 and molded ducts 12 and 14. To assemble air induction system 10, the outwardly flared portion 56 of end 52 of metal substrate 16 is abutted against sloped surface 40 on raised ridge 36 of molded duct 12. Over molded connection joint 18 is then formed about end portions 32 and 52 using a known injection molded process or other suitable molding process to produce a joint designed to provide a permanent leak resistant connection. Likewise, outwardly flared portion 58 of end 54 of metal substrate 16 is abutted against sloped surface 42 of raised ridge 38 on end portion 34 of molded duct 14, and a similar over molded connection joint 18 is injection molded thereabout.

In operation, air will flow through the air induction system 10 to be taken in by the engine to facilitate combustion. When the engine is shut off, fuel that evaporates after being discharged from the fuel injectors but has not been consumed by the engine will be adsorbed by the adsorbent or absorbent layer on the inner surface 50 of metal substrate 16. Consequently, when the engine is restarted and intake air passes through air induction system 10, the air will purge any adsorbed unburned fuel and carry it to the engine to be combusted there.

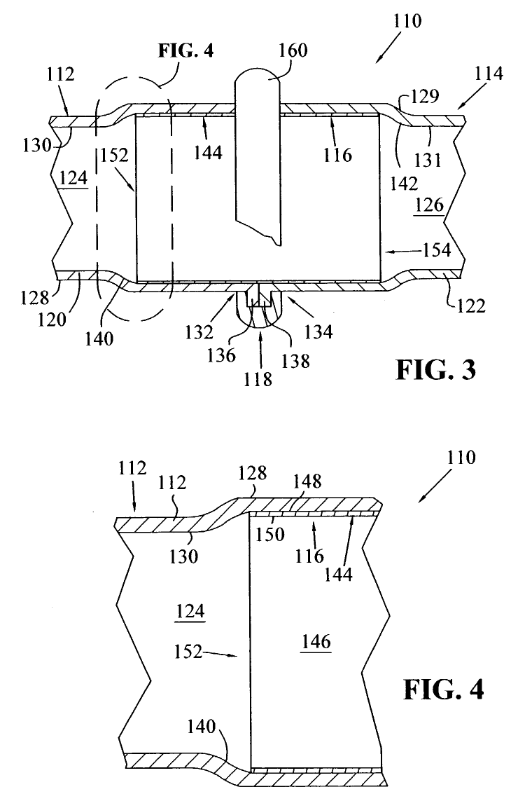

An alternate embodiment air induction system 110 is shown in FIGS. 3 and 4. Alternate induction system 110 includes a pair of molded/polymer members or ducts generally indicated as 112 and 114 and a metal substrate generally indicated as 116. In this embodiment, metal substrate 116 is located within molded ducts 112 and 114, which are connected with a connection joint 118.

Molded ducts 112 and 114 include respective walls, 120, 122 and inner flow passages 124, 126. Walls 120 and 122 have respective outer surfaces 128, 129 and inner surfaces 130, 131. Molded duct 112 has an end portion generally indicated as 132, and molded duct 114 has an end portion generally indicated as 134. End portion 132 of molded duct 112 includes a flange 136, and end portion 134 of molded duct 114 includes a flange 138. Flanges 136 and 138 extend perpendicularly outward from outer surfaces 128, 129, respectively. The diameter of inner air flow passages 124 and 126 is greater at the respective end portions 132, 134. Molded duct 112 has a shoulder 140 at the diameter transition area of inner air flow passage 124, and molded duct 114 has a similar shoulder 142 at the diameter transition area of inner air flow passage 126.

Metal substrate 116 is formed in a cylindrical or tubular configuration and includes a wall generally indicated as 144 and an inner air flow passage 146. Wall 144 has an outer surface 148 and an inner surface 150. Inner surface 150 may be coated with the described absorbent or adsorbent affixed as described before.

Connection joint 118 may be formed from a injection molded material 160. To assemble air induction system 110, metal substrate 116 is partially inserted into either end portion 132 of molded duct 112 or end portion 134 of molded duct 114. The end of the opposing molded duct is then slid over the other end of the metal substrate 116 and the molded ducts are brought together until flanges 136 and 138 are abutting one another. A small space or gap may also be left between flanges 136 and 138 to allow injection mold material 160 to be forced therein to enhance the connection. Once the flanges are set into position, connection joint 118 can be over molded with injection molded material 160 using the injection molding process to produce a permanent leak resistant connection. It should also be realized that as an alternative, connection joint 118 may also be formed from a hot plate weld or spin weld in lieu of using an injection over mold. The induction system 110 will operate similar to induction system 10.

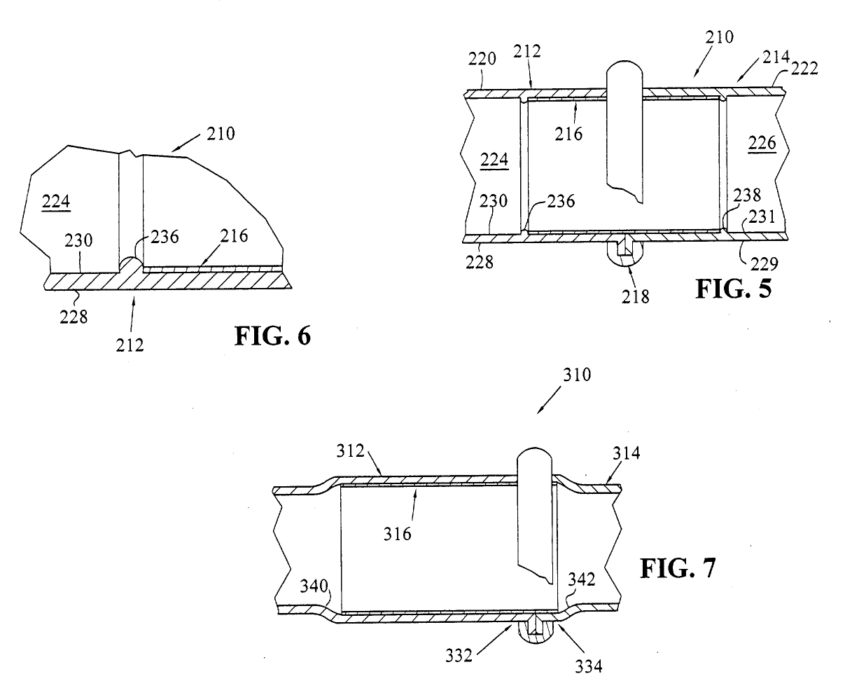

Now referring to FIGS. 5 and 6, another embodiment of the invention is shown including an air induction system generally indicated as 210. Air induction system 210 includes a pair of molded/polymer members or ducts generally indicated as 212 and 214 and a metal substrate generally indicated as 216 located within the molded ducts. Molded ducts 212 and 214 are connected with a connection joint generally indicated as 218.

Molded ducts 212 and 214 include respective walls 220 and 222 and inner air flow passages 224 and 226. Walls 220 and 222 include respective outer surfaces 228, 229 and inner surfaces 230, 231. Molded ducts 212 and 214 are similar to molded ducts 112 and 114 except that the diameter of the inner air flow passages 224 and 226 may be undifferentiated except for small locating ribs 236 and 238 extending inwardly from inner surfaces 230, 231, respectively. The optional locating ribs need not be continuous on the inner surfaces 230, 231. One or more pins, bump or other shape of radially inward protrusion preferably molded into the molded duct may be used. Also, one or more pins may be inserted through the walls 220, 222, subsequent to the molding step. Also, the substrate 216 may be installed within the ducts 212 and 214 without the benefit of a locating feature within the ducts. Air induction system 210 is assembled and operated the same as air induction system 110 except that metal substrate 216 is located between locating ribs 236 and 238 instead of between shoulders 140 and 142.

Another embodiment of an air induction system is shown in FIG. 7 and generally indicated as 310. Air induction system 310 includes a pair of molded/polymer members or ducts generally indicated as 312 and 314 and a metal substrate generally indicated as 316. Molded ducts 312 and 314 have end portions generally indicated as 332 and 334 and shoulders 340 and 342, respectively.

Air induction system 310 is similar in assembly and operation to air induction system 110 except that shoulder 340 is located farther away from the end portion than shoulder 140 and shoulder 342 is closer to the end portion than shoulder 142. Accordingly, substrate 316 is located predominately or completely within molded duct 312.

While the invention has been taught with specific reference to the above described embodiments, one skilled in the art will recognize that changes can be made in form and detail without departing from the spirit and scope of the invention. For example, although the molded ducts have been shown in a hollow cylindrical form, it should be realized that the ducts may take on any configuration that will adequately allow air to pass through, such as a rectangular configuration. In addition, the molded ducts may also be pleated or bellowed in order to provide flexibility.

Additionally, although the metal substrate has been shown in a tubular configuration, it should be realized that other configurations may be used to match the configuration of the molded ducts or as otherwise desired. Also, the metal substrate may include baffles or other means that have been coated with a hydrocarbon adsorbing material in order to increase the surface area and efficiency of removal of any hydrocarbons/unburned fuel. In addition, the connection configurations shown for the over molded connection joint are for illustrative purposes only, and any suitable configuration that will provide the desired over molded connection may be employed. Furthermore, the connections may be made with other suitable processes such as threads, snap locks, or adhesive that may provide a permanent leak resistant joint. Therefore, the described embodiments are to be considered in all respects only as illustrative and not restrictive. The scope of the invention is, therefore, indicated by the following claims rather than by the description or drawings.

What is claimed is:

1. An air induction system for inspiration of clean air into an engine, said system comprising:
a pair of hollow molded members for communication of air flow therethrough, each of said molded members having an end; and
a metal substrate having a hollow passage, said metal substrate located between said ends of said molded members and having a first end and a second end, said first end connected to said end on one of said molded members, and second end connected to said end on the other molded member to form a pathway for air to flow through said molded members and said metal substrate.

2. The air induction system as set forth in claim 1, wherein an interior portion of said metal substrate is coated with a material for absorbing or adsorbing hydrocarbons.

3. The air induction system as set forth in claim 2, wherein said metal substrate is connected to said molded members with an over molded connection joint.

4. The air induction system as set forth in claim 3, wherein said connection joint provides a permanent leak resistant connection between the metal substrate and molded members.

5. The air induction system as set forth in claim 1, wherein at least one of said first or second ends of said metal substrate is flared outwardly.

6. The air induction system as set forth in claim 5, wherein at least one of said molded members has a raised ridge extending around an outer surface thereof.

7. The air induction system as set forth in claim 6, wherein said raised ridge includes a sloped surface.

8. The air induction system as set forth in claim 7, wherein said outwardly flared end of said metal substrate is fitted against said sloped surface on said ridge of said one molded member.

9. The air induction system as set forth in claim 8, wherein said outwardly flared end of said metal substrate is connected to said raised ridge on said one molded member using an over molded connection joint.

10. The air induction system as set forth in claim 9, wherein both ends of said metal substrate are flared outwardly and both of said molded members have a raised ridge adjacent said ends, and an over molded connection joint is also formed over said outwardly flared second end of said metal substrate and said raised ridge on said other molded member.

11. An air induction system for inspiration of clean air into an engine, said system comprising:
a pair of hollow molded members for communication of air flow therethrough, each of said molded members having an end, said ends being connected together; and
a metal substrate having a hollow passage, said metal substrate located within at least a portion of one of said molded members, and said metal substrate coated with a material on an interior surface thereof for absorbing or adsorbing hydrocarbons in said air induction system, said molded members and said metal substrate forming a pathway for air to flow therethrough.

12. The air induction system as set forth in claim 11, wherein said portion of said one molded member includes a shoulder, said metal substrate abutted against said shoulder.

13. The air induction system as set forth in claim 11, wherein each of said molded members has a shoulder and said metal substrate is located between said shoulders.

14. The air induction system as set forth in claim 1, wherein said ends of said molded members are connected with an over molded connection joint or a weld joint.

15. The air induction system as set forth in claim 14, wherein said overmolded joint provides a permanent leak resistant connection between said molded members.

16. An air induction system for inspiration of clean air into an engine, said system comprising:
a pair of hollow molded members for communication of air flow therethrough; and
a metal substrate located between said molded members, said metal substrate having a hollow passage and coated with a material for absorbing or adsorbing hydrocarbons in said induction system, said metal substrate connected to each of said molded members by an over molded connection joint to form a pathway for air to flow through said molded members and said metal substrate.

17. The air induction system as set forth in claim 16, wherein each of said molded members has an end and said metal substrate has a first end and a second end, at least one of said first or second ends of said metal substrate being flared outwardly.

18. The air induction system as set forth in claim 16, wherein said connection joint provides permanent leak resisting connection between the metal substrate and molded members.

19. The air induction system as set forth in claim 17, wherein at least one of said molded members has a raised ridge extending around an outer surface thereof.

20. The air induction system as set forth in claim 19, wherein said raised ridge includes a sloped surface, and said outwardly flared end of said metal substrate is fitted against said sloped surface on said ridge of said one molded member, said over molded connection joint encompassing said outwardly flared end of said metal substrate and said raised ridge on said one molded member.
